(19) United States
(12) Patent Application Publication
(10) Pub. No.: US 2010/0032272 A1
(43) Pub. Date: Feb. 11, 2010

(54) KEY STRUCTURE

(75) Inventor: Chih-Hsiang Chiang, Jungli City (TW)

Correspondence Address: QUINTERO LAW OFFICE, PC, 615 Hampton Dr, Suite A202, Venice, CA, 90291, US

(73) Assignee: DARFON ELECTRONICS CORP., TAOYUAN (TW)

(21) Appl. No.: 12/535,622

(22) Filed: Aug. 4, 2009

(30) Foreign Application Priority Data
Aug. 6, 2008 (TW) TW97214036

(51) Int. Cl. H01H 13/70

(52) U.S. Cl. 200/344

(57) ABSTRACT

A key structure includes a first keycap, a second keycap, a base, a first extending part extended under the first keycap from the second keycap and rotatably connected to the base, an elastomer located under the first keycap and supported by the base, and a second extending part extending under the first keycap from the second keycap and rotatably connected to the base. The elastomer is located between the first and second extending parts. The second extending part includes a flexible material. The shape and size of the second extending part is the same as that of the first extending part. The first extending part includes a first segment connected to the second keycap and a second segment connected to the base. An acute angle is formed between the second segment of the first extending part and the base.

### CROSS REFERENCE TO RELATED APPLICATIONS

This Application claims priority of Taiwan Patent Application No. 97214036, filed on Aug. 6, 2008, the entirety of which is incorporated by reference herein.

### BACKGROUND OF THE INVENTION

1. Field of the Invention

The present invention relates to a key structure providing an extending part, and in particular relates to a key structure substantially configured as a thin structure.

2. Description of the Related Art

Today's computers are provided with various functions such as video and audio, etc. for, as an example, gaming or meetings, which use keyboards as a main interface device. Thus, a computer keyboard has a variety of functions.

FIG. 1 is a cross-section view of a conventional key structure 10. The key structure 10 includes a keycap 101, two supporting portions 102, an elastomer 103 and a base plate 104.

The keycap 101 is supported by the two supporting portions 102, the elastomer 103 is located below the keycap 101, and the two supporting portions 102 and the elastomer 103 are supported by the base plate 104.

In addition, the two supporting portions 102 located between the keycap 101 and the base plate 104 pivot in relation to the keycap 101 and the base plate 104, so that the keycap 101 is moved up and down with respect to the elastomer 103.

For the conventional key structure 10, the two supporting portions 102 directly pivot between the keycap 101 and the base plate 104, so that the keycap 101 can horizontally move up and down with respect to the base plate 104. Because the conventional key structure 10 must have a predetermined thickness for horizontal movement of the two supporting portions 102, miniaturization and methods to simplify the assembly process are hindered.

### BRIEF SUMMARY OF THE INVENTION

To miniaturize the conventional key structure and simplify the manufacturing process thereof, the invention provides a key structure including a first keycap, a second keycap, a base and a first extending part which extends under the first keycap from the second keycap and is rotatably connected to the base.

One feature of the key structure of the invention further provides an elastomer located under the first keycap and supported by the base.

Another feature of the key structure of the invention is that the first extending part is located beside the elastomer.

Another feature of the key structure of the invention further provides a second extending part extending under the first keycap from the second keycap and rotatably connected to the base, wherein the elastomer is located between the first and second extending parts.

Another feature of the key structure of the invention is that the second extending part comprises a flexible material.

Another feature of the key structure of the invention is that the shape and size of the second extending part is the same as that of the first extending part.

Another feature of the key structure of the invention is that the first extending part comprises a first segment connected to the second keycap and a second segment connected to the base.

Another feature of the key structure of the invention is that an acute angle is formed between the second segment of the first extending part and the base.

Another feature of the key structure of the invention is that the second segment of the first extending part is formed as an L-shape.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a cross-section view of a conventional key structure.

FIG. 2 is a schematic view of a key structure of an embodiment of the invention.

FIG. 3 is a top view of a key structure of an embodiment of the invention.

FIG. 4 is a schematic view of a first extending part of the invention.

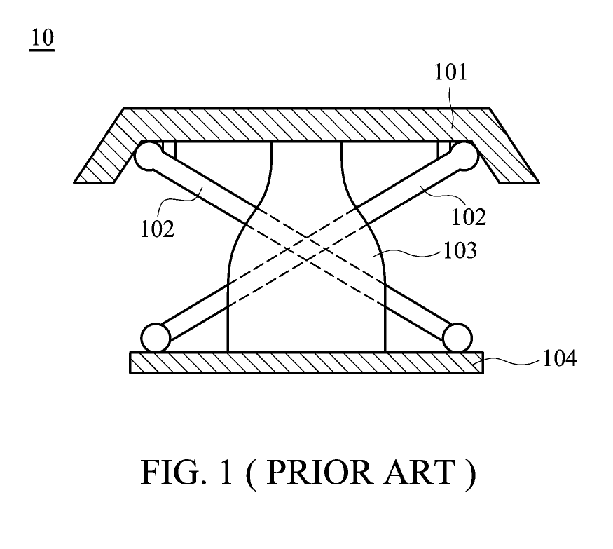

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

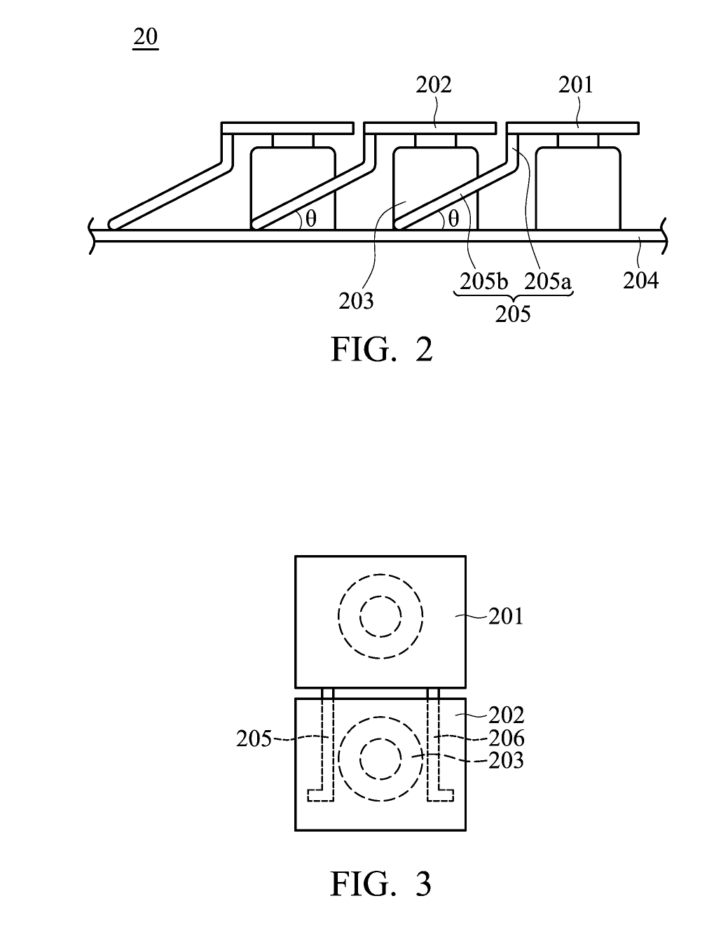

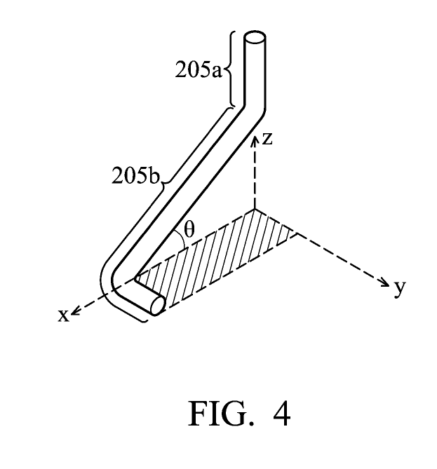

FIG. 2 is a schematic view of a key structure 20 of an embodiment of the invention. The key structure 20 comprises a plurality of first keycaps 202 and a plurality of second keycaps 201. To simplify description of the structural features of the key structure 20, only a single first keycap 202 and a single second keycap 201 are illustrated hereinafter. Referring to FIGS. 2, 3 and 4 simultaneously, the key structure 20 comprises the first keycap 202, the second keycap 201, an elastomer 203, a base 204, a first extending part 205 and a second extending part 206.

The elastomer 203 is located under the first keycap 202 and is supported by the base 204.

The first and second extending parts 205 and 206, located at both sides of the elastomer 203, are extended under the first keycap 202 from the second keycap 201 and rotatably connected to the base 204, so that the second keycap 201 is capable of moving up and down with respect to the base 204. In this embodiment, the first and second extending parts 205 and 206 are made of flexible material, the first and second extending parts 205 and 206 have the same size and shape, and the first and second extending parts 205 and 206 and the second keycap 201 are integrally formed.

Further, the first extending part 205 comprises a first segment 205a connected to the second keycap 201 and a second segment 205b connected to the base 204. In this embodiment, the second segment 205b has an L-shape, and an acute angle θ is formed between the second segment 205b of the first extending part 205 and the base 204.

The embodiment utilizes the same shape and size of the first and second extending parts 205 and 206 of the key structure 20 as opposed to the scissor-like key structure of the conventional method. With the first and second extending parts 205 and 206 extending under the first keycap 202 from the second keycap 201 and rotatably connected to the base 204, the second keycap 201 therefore can horizontally move up and down with respect to the base 204.

Therefore, the total thickness of the key structure 20 can be miniaturized and controlled by the angle θ formed between the second segment 205b of the first extending part 205 and the base 204. When the second keycap 201 of the key structure 20 is horizontally moved up and down, the problem such as unequal acting force is eliminated. Further, due to the same shape and size of the first and second extending parts 205 and 206 and the first and second extending parts 205 and 206 and the second keycap 201 being integrally formed, the manufacturing process of the key structure 20 is simplified, thus, increasing the efficiency of the manufacturing process thereof, saving time and costs.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A key structure, comprising:
a first keycap;
a second keycap;
a base; and
a first extending part extending under the first keycap from the second keycap and rotatably connected to the base.

2. The key structure as claimed in claim 1 further comprising an elastomer located under the first keycap and supported by the base.

3. The key structure as claimed in claim 2, wherein the first extending part is located beside the elastomer.

4. The key structure as claimed in claim 2 further comprising a second extending part extending under the first keycap from the second keycap and rotatably connected to the base, wherein the elastomer is located between the first and second extending parts.

5. The key structure as claimed in claim 4, wherein the second extending part comprises a flexible material.

6. The key structure as claimed in claim 4, wherein the shape and size of the second extending part is the same as that of the first extending part.

7. The key structure as claimed in claim 1, wherein the first extending part comprises a first segment connected to the second keycap and a second segment connected to the base.

8. The key structure as claimed in claim 7, wherein an acute angle is formed between the second segment of the first extending part and the base.

9. The key structure as claimed in claim 7, wherein the second segment of the first extending part comprises an L-shape.

10. The key structure as claimed in claim 1, wherein the first extending part and the second keycap are integrally formed.

11. The key structure as claimed in claim 1, wherein the first extending part comprises a flexible material.
